(19) United States
(12) Patent Application Publication
(10) Pub. No.: US 2012/0304121 A1
(43) Pub. Date: Nov. 29, 2012

(54) METHOD, PROCESSING DEVICE, AND ARTICLE OF MANUFACTURE FOR PROVIDING INSTRUCTIONS FOR DISPLAYING TIME-DEPENDENT INFORMATION AND FOR ALLOWING USER SELECTION OF TIME RANGES

(75) Inventors: Corey Donn Patrick CAHILL, Toronto (CA); Scott Anthony Herbert GUEST, Dartmouth (CA); Milos GLISIC, Toronto (CA); Miljan BRATICEVIC, Toronto (CA)

(73) Assignee: COMPONENTART HOLDINGS INC., Toronto (CA)

(21) Appl. No.: 13/115,507

(22) Filed: May 25, 2011

(51) Int. Cl. G06F 3/048

(52) U.S. Cl. 715/815; 715/810

(57) ABSTRACT

A method of displaying time-dependent information is used to provide a time navigation window for aiding a user in selecting data to be displayed in a chart. A first sequence of first selectable time intervals and a second sequence of second selectable time intervals are displayed in a hierarchical arrangement in a viewport in the time navigation window. The first and second selectable time intervals have first and second time scales, respectively, and each have a respective selectable area for display. The time-dependent data is displayed in the time intervals or selectable areas thereof of at least one the first and second sequences. A user can select one or more of the time intervals for changing range of time for display of the data within the viewport or for changing a range of time for display of the data in an area outside the viewport.

### TECHNICAL FIELD

The present disclosure relates to computer system graphical user interfaces, and more particularly to computer system graphical user interfaces for user selection of time intervals and time scales for display of time-dependent information.

### BACKGROUND

There is a large number of visual tools available for aiding a user in selecting time/date ranges for displaying data as a function of time. Such tools are used to provide Google Finance charts or Yahoo Finance charts, for example. However, such tools provide the user with only limited capabilities for navigating around the data and time ranges. Particularly, although a user has the ability to select particular ranges of time for displaying time-dependent data, such as financial data for example, the number of ways a user can define a particular range of time is limited. Furthermore, the tools that are available do not allow the user to quickly and easily zoom in and out of ranges time or specify times scales to be viewed.

### SUMMARY

According to a first broad aspect, a method of providing instructions for displaying time-dependent information and for allowing user selection of time ranges is provided. The method involves: responsive to receiving first instructions defining a range of time for displaying time-dependent data in a viewport, determining a first sequence of first selectable time intervals to be displayed in the viewport. The first selectable time intervals have a first time scale and each have a respective first selectable area for display. In response to the first instructions a second sequence of second selectable time intervals to be displayed in the viewport is also determined. The second selectable time intervals have a second time scale different than the first time scale and each have a respective second selectable area for display. Second instructions for displaying the first sequence of first selectable time intervals and the second sequence of second selectable time intervals in a hierarchical arrangement are provided. Third instructions for displaying the time-dependent data in at least one of the respective first selectable area of the first selectable time intervals and the respective second selectable area of the second selectable time intervals are also provided.

Advantageously, displaying the time-dependent data in at least one of the respective first selectable area of the first selectable time intervals and the respective second selectable area of the second selectable time intervals allows a user to quickly and easily identify and select a range of time of interest.

In some embodiments, instructions for displaying a scroll bar for user selection of the range of time for displaying the time-dependent data in the viewport are provided. In some embodiments, the scroll bar is a re-sizable scroll bar.

In some embodiments, the method involves selecting at least one of the first selectable time intervals of the first sequence or at least one of the second selectable time intervals of the second sequence and providing the first instructions in response to the selection. In some embodiments, a mouse wheel is used for the selection. In some embodiments, a touch gesture is used for the selection.

In some embodiments, the method involves: responsive to receiving fourth instructions defining a display range of time for displaying at least some of the time-dependent data in an area outside the viewport, providing fifth instructions for displaying a user re-sizable selection window overlaying at least one of the first selectable time intervals of the first sequence and the second time intervals of the second sequence, the user re-sizable selection window indicating the display range of time.

Advantageously, a user can re-size the selection window for re-defining the display range of time.

In some embodiments, instructions for displaying a scroll bar for user selection of the display range of time are provided. In some embodiments, instructions for displaying a re-sizable scroll bar for user selection of the display range of time are provided.

In some embodiments, the re-sizable selection window is re-sized and the first instructions are provided in response to re-sizing of the re-sizable selection window.

In some embodiments, a mouse wheel is used for re-sizing the re-sizable selection window. In some embodiments, a touch gesture is used for re-sizing the re-sizable selection window.

In some embodiments, the first time scale has associated with it a plurality of formats for labeling the first selectable time intervals of the first sequence with identifiers of the first selectable time intervals of the first sequence, each format requiring a respective other area for display. The method involves: selecting from the plurality of formats a format that has the respective other area suitable for display in the respective first selectable area of the first selectable time intervals of the first sequence. The method also involves labeling the first selectable time intervals of the first sequence with the identifiers of the first selectable time intervals of the first sequence using the selected format.

In some embodiments, the second time scale has associated with it a plurality of other formats for labeling the second selectable time intervals of the second sequence with other identifiers of the second selectable time intervals of the second sequence, each other format requiring a respective other area for display. The method involves selecting from the plurality of other formats an other format that has a respective other area suitable for display in the respective second selectable area of the second selectable time intervals of the second sequence. The method also involves labeling the second selectable time intervals of the second sequence with the other identifiers of the second selectable time intervals of the second sequence using the selected other format.

In some embodiments, the method involves: providing instructions for displaying at least one selectable item each defining the range of time for displaying time-dependent data in a viewport.

According to a second broad aspect, a processing device for providing instructions for displaying time-dependent information and for allowing user selection of time ranges is provided. The processing device has a communications interface; a processor coupled to the communications interface; and a memory coupled to the processor. The memory has first instructions executable by the processor for: responsive to receiving through the communications interface second instructions defining a range of time for displaying time-dependent data in a viewport, determining a first sequence of first selectable time intervals to be displayed in the viewport. The first selectable time intervals have a first time scale and each have a respective first selectable area for display. Responsive to receiving through the communications interface the second instructions a second sequence of second selectable time intervals to be displayed in the viewport is also determined. The second selectable time intervals have a second time scale different than the first time scale and each have a respective second selectable area for display. Third instructions for displaying the first sequence of first selectable time intervals and the second sequence of second selectable time intervals in a hierarchical arrangement are provided and fourth instructions for displaying the time-dependent data in at least one of the respective first selectable area of the first selectable time intervals and the respective second selectable area of the second selectable time intervals are also provided.

According to a third broad aspect, an article of manufacture is provided. The article of manufacture has a computer usable medium having computer readable program code means embodied therein for providing instructions for displaying time-dependent information and for allowing user selection of time ranges. The computer readable code means in the article of manufacture has computer readable code means for: responsive to receiving first instructions defining a range of time for displaying time-dependent data in a viewport, determining a first sequence of first selectable time intervals to be displayed in the viewport. The first selectable time intervals have a first time scale and each have a respective first selectable area for display. Responsive to receiving the first instructions and a second sequence of second selectable time intervals to be displayed in the viewport is also determined. The second selectable time intervals have a second time scale different than the first time scale and each have a respective second selectable area for display. The computer readable code means in the article of manufacture has computer readable code means for providing second instructions for displaying the first sequence of first selectable time intervals and the second sequence of second selectable time intervals in a hierarchical arrangement and computer readable code means for providing third instructions for displaying the time-dependent data in at least one of the respective first selectable area of the first selectable time intervals and the respective second selectable area of the second selectable time intervals.

### BRIEF DESCRIPTION OF THE DRAWINGS

The features and advantages will become more apparent from the following detailed description of the preferred embodiment(s) with reference to the attached figures, wherein:

FIG. 1 is a flow chart of a method of providing instructions for displaying time-dependent information, in accordance with a preferred embodiment;

FIG. 2 is an exemplary display generated using the method of FIG. 1;

FIG. 3 is an exemplary hierarchical structure of time level as specified by a developer for determining sequences of time intervals to be displayed in the method of FIG. 1;

FIG. 4 is a flow chart of a method of generating sequences of time interval for display in a viewport, in accordance with another embodiment of the invention;

FIG. 5 is an exemplary time navigation window generated using the method of FIG. 1;

FIG. 6 is a flow chart of a method labeling times interval of a sequence of time intervals displayed in a viewport, in accordance with another embodiment;

FIG. 7 is a flow chart of a method of selecting a combination of time levels for displaying sequences of time interval in a hierarchical arrangement, in accordance with another embodiment;

FIG. 8A is an exemplary display of a time navigation window showing a user selection of two time intervals;

FIG. 8B is an exemplary display of a time navigation window being displayed after a user selection of the two time intervals of FIG. 8A; and,

FIG. 8C is an exemplary display of a time navigation window being displayed after a user initiated re-sizing of the viewport range of time of FIG. 8B; and,

FIG. 9 is a block diagram of a processing device, for providing the display of FIG. 2.

It is noted that in the attached figures, like features bear similar labels.

### DETAILED DESCRIPTION OF THE PREFERRED EMBODIMENTS

Embodiment described therein disclose a time navigation tool aiding a user in selecting date or time ranges for displaying time-dependent data, such as financial data or other data having a time associated with the data.

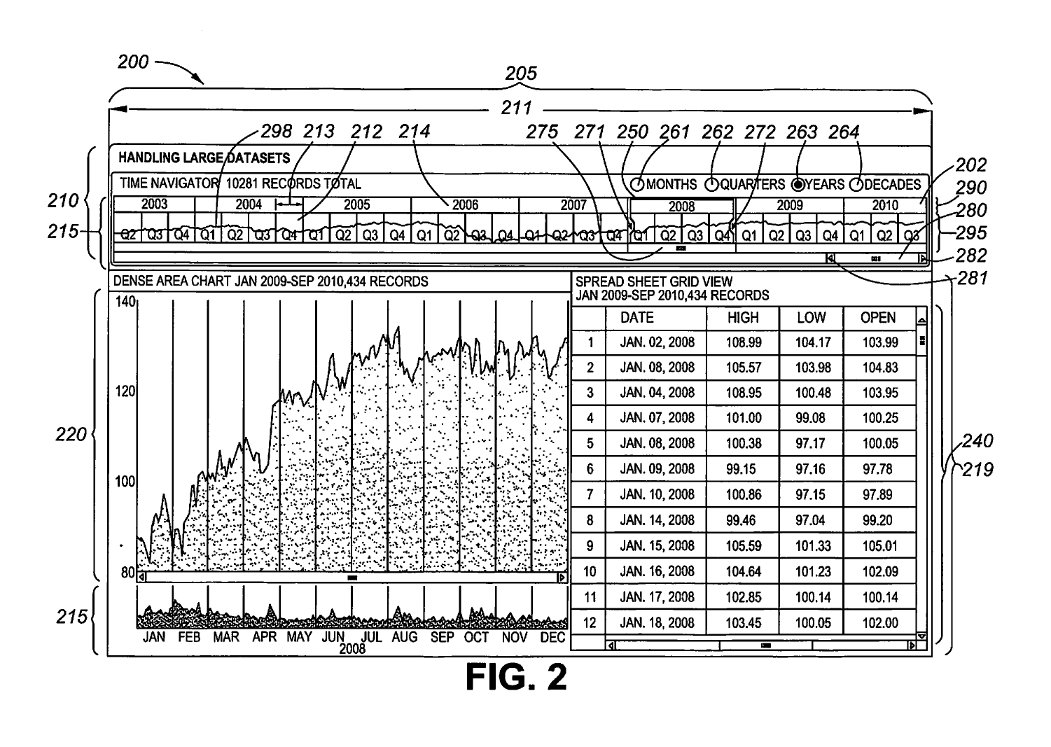

Referring to FIG. 2, shown is an exemplary display, generally indicated by 200, in accordance with an embodiment. The display 200 includes time navigation window 210 and a dashboard 219. The dashboard 219 has charts 220, 230, and a spreadsheet 240. The time navigation window 210 has a viewport 215 having a first sequence 290 of time intervals or units of time and a second sequence 295 of time intervals or units of time. The time sequence 290 includes years as time intervals which are identified years 2003, 2004, 2005, 2006, 2007, 2008, 2009, and 2010. The sequence 295 includes quarters within a year as time intervals, which are identified as Q1, Q2, Q3, Q4 for each year. Year 2008 in the viewport 215 is highlighted with a selection window 250. The selection window 250 has a re-sizable scroll bar 275 with a thumb position 271 and an index position 272. The viewport 215 also has a re-sizable scroll bar 281 having thumb position 281 and an index position 282. The time navigation window also has selectable buttons 261, 262, 263, 264. Displayed in the space allocated to the time intervals of the sequence 295 are time-dependent data 298. The data 298 are plotted as a function of time within each time interval of the sequence 295. Advantageously, by plotting the data 298 within the time intervals of the sequence 295 a user can quickly and with easy focus in on a range of time of interest and select this range for display in the dashboard 219.

The selection window 250 is used to define the range of time over which data in charts 220, 230 of the dashboard 219 are displayed. Particularly the leftmost and rightmost ends of the selection window 250 define the start and end times, respectively, for displaying time-dependent data. For example, in FIG. 2 the selection window 250 spans over Quarters Q1, Q2, Q3, Q4 of year 2008 and data between January and December 2008 are displayed in charts 220, 230. The scroll bar 275 is used to move the selection window 250 left or right to set display settings to another range of time. For example, a user can move the scroll bar 275 by selecting the scroll bar 275 with a click of a mouse button and moving the scroll bar 275 to the left or right using the mouse. The thumb position 271 and the index position 272 are used to expand or contract the selection window 250, respectively. For example, a user can select the thumb position 271 using a mouse and drag the leftmost end of the selection window to the left or right to decrease or increase the start time, respectively. In addition, the user can select the index position 272 using a mouse and drag the rightmost end of the selection window to the left or right to decrease or increase the end time, respectively. Re-sizing the selection window 250 creates a “zoom” effect in the display of data in charts 220, 230 of the dashboard 219.

The viewport 215 shown in FIG. 2 displays only a portion of a navigable range of time, the navigable range of time being defined by a start time and an end time. This portion of the navigable range that is displayed is referred to the viewport range. For example, in the exemplary illustration of FIG. 2 the navigable range is defined by the start time of 0:00 am, Jan., 1, 1970 and the end time of 0:00 am, Jan. 1, 2011 (not shown). However, the visible range displayed in viewport 215 is only a subset of this navigable range. Particularly, sequences 290, 295 span over a range of time between Quarter Q2 of 2003 and Quarter Q3 of 2010. The scroll bar 280 is used to change the time range of the viewport 215. For example, in FIG. 2 the time range in viewport 215 is set between a start time corresponding to Quarter Q2 of year 2003 and an end time corresponding to Quarter Q3 of 2010. A user can select the scroll bar 280 by clicking a mouse button and drag the scroll bar 280 left or right to increase or decrease, respectively, both the start time and the end time of sequences 290, 295 in the viewport 215. The thumb position 281 and the index position 282 are used to expand or contract the time interval, respectively, between the start time and the end time of sequences 290, 295 in the viewport 215. For example, a user can select the thumb position 281 by clicking a mouse button and drag the thumb position 281 to the left or right using the mouse to decrease or increase the start time for the viewport 215, respectively. In addition, the user can select the index position 282 using the mouse button and drag the index position 282 to the left or right to decrease or increase the end time for the viewport 215, respectively.

The sequences 290, 295 each have a start time and an end corresponding to 0:00 am, Jan., 1, 2003, and 0:00 am Oct. 1, 2010, respectively. The scroll bar 275 and the re-sizing buttons 271, 272 can also be used to redefine the sequences 290, 295 in the viewport 215. For example, dragging the scroll bar 275 to the left all the way to an end 201 of the viewport 215 using a mouse, for example, causes both the start and end times of the sequences 290, 295 to decrease, and the decrease continues as long as the mouse button on the mouse is pressed or until the start time of the navigation range is reached. Similarly, dragging the scroll bar 275 to the right all the way to an end 202 of the viewport 215 causes the both the start and end times of the sequences 290, 295 to increase, and the increase continues as long as the mouse button on the mouse is pressed or until the end time of the navigation range is reached. Dragging the thumb position 271 to the left all the way to the end 201 of the viewport 215 causes the start times of the sequences 290, 295 to decrease, and the decrease continues as long as the mouse button on the mouse is pressed or until the start time of the navigation range is reached. Dragging the index position 272 to the right all the way to the end 202 of the viewport 215 causes the end times of the sequences 290, 295 to increase, and the increase continues as long as the mouse button on the mouse is pressed or until the end time of the navigation range is reached. Re-sizing the viewport range of time creates a “zoom” effect in the display of data 298 in the viewport 215.

The scrolling and re-sizing operations discussed above involve a click operation using a mouse button and a dragging operation by movement of the mouse. Alternatively, the scrolling and re-sizing operations can be made using clockwise and counter-clockwise movements of a mouse wheel instead of movement of the mouse itself. In some implementations, the scrolling and re-sizing is made using touch gestures on a touch screen or pad. For example, a “flick gesture” to the left or right anywhere in the viewport 215, or in some implementations anywhere on a screen displaying the display 200, results in the time period of the viewport range of time decreasing or increasing, respectively. Alternatively, in some implementations, changing the time period of the viewport range using a “flick “gesture requires a “flick” gesture at the scroll bar 280. A “flick gesture” to the left causes a decrease in both the start and end times of the viewport range of time and a “flick gesture” to the right causes an increase in both the start and end times of the viewport range of time. Alternatively, a double-finger or multi-finger drag operation can be used to effect a scrolling operation for changing the time period of the viewport range. Pinch gestures can also be used for changing the time period of the viewport range. A pinching inwards gesture made by bringing the thumb and index of a hand towards each other, for example, can be used to decrease the start time of the viewport range of time and increase the end time of the viewport range of time, thereby causing a “zoom out” operation in the viewport range of time. A pinching outwards gesture made by spreading the thumb and index away from each other, for example, can be used to increase the start time of the viewport range of time and decrease the end time of the viewport range of time, thereby causing a “zoom in” operation in the viewport range of time. A combination of “pinch” and “flick” gestures are also used to create combined zooming and scrolling operations. A new selection window can also be determined using gestures. For example, a user can select a particular time interval of any one of the sequences 290, 295 by tapping a finger on the time interval to be selected for a new selection window. In addition, a user can select a plurality of time intervals of any one of the sequences 290, 295 by tapping a finger on a first time interval and dragging the finger to select additional time intervals for a new selection window.

The selectable buttons 261, 262, 263, 264 are used to select pre-defined views in the viewport 215. More particularly, buttons 261, 262, 263, 264 are used to select pre-defined views associated with “Months”, “Quarter”, “Years”, and “Decades”, respectively. Other examples include but are not limited to “Today” and “Last Year”. Selection of one of the selectable buttons 261, 262, 263, 264 may result in a new viewport range of time and time intervals of different time levels or time scales being displayed. In some implementations, animation is provided in the viewport 215 to provide a smooth visual transition from one display to another.

In the exemplary implementation of FIG. 2, buttons are used for selecting pre-defined views. However, in other implementations other selectable items such as radio buttons and/or drop-down boxes, for example, are used to select pre-defined views.

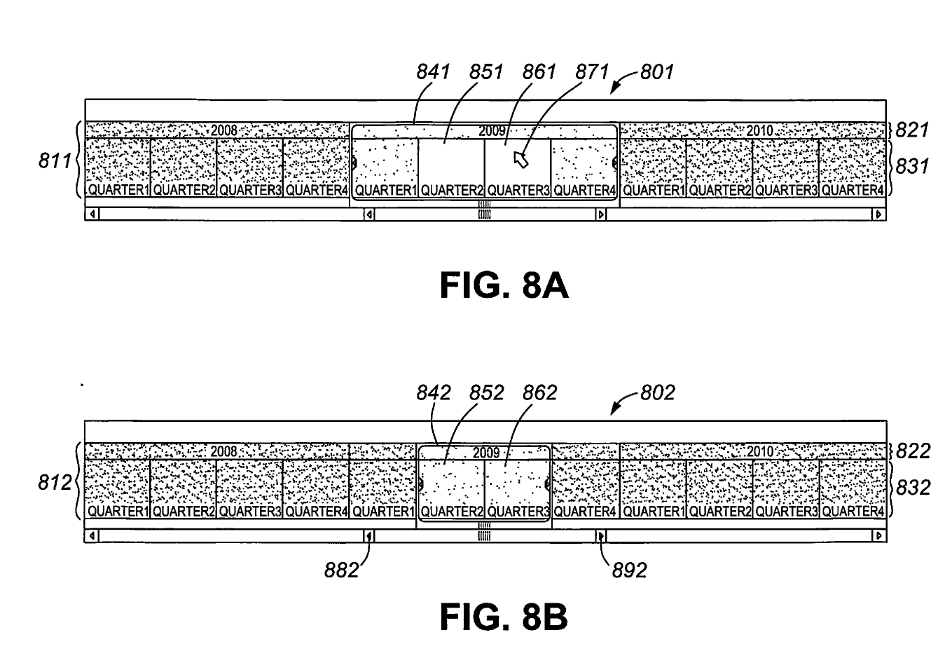

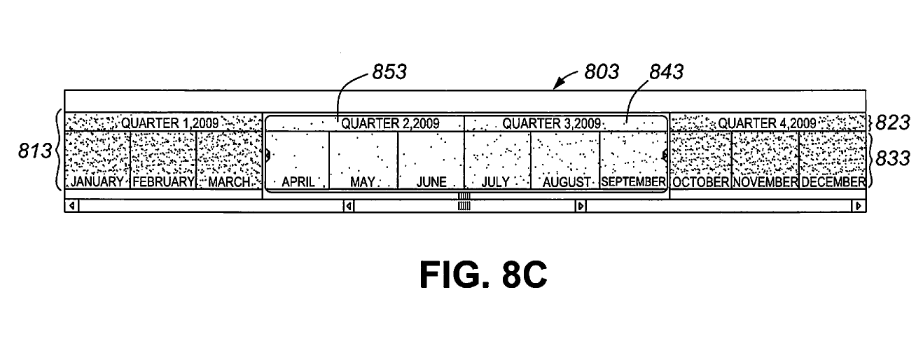

In addition to using pre-defined states, or scrolling or re-sizing operations to re-draw the selection window 250, a user can select one or more time intervals to change the display setting range of time of the selection window 250. Further details of how a user can the range of time for displaying data will now be discussed with reference to FIGS. 8A to 8B. In FIG. 8A a navigation window 801 has a viewport 811 having a first sequence 821 of time intervals, a second sequence 831 of time intervals, and a selection window 841. In FIG. 8B a navigation window 802 has a viewport 812 having a first sequence 822 of time intervals, a second sequence 832 of time intervals, and a selection window 842. With reference to FIG. 8A, a user has highlighted the time intervals 851, 861 by moving a cursor 871 to the time interval 851, clicking on a mouse button and dragging the cursor to time interval 861, for example. FIG. 8B shows the resulting selection window 842 after the user has selected time intervals 851, 861 of sequence 831 in FIG. 8A, which correspond to Quarters 2 and 3 of year 2009, respectively. In FIG. 8B, the selection window 842 has been re-drawn to include time intervals 851, 852 of sequence 822, which correspond to Quarters 2 and 3 of year 2009 as selected by the user in FIG. 8A. In FIG. 8A, a re-sizing operation was made in response to a user selection of two time intervals of the sequence 831. More generally, a re-sizing operation is made in response to a user selection of one or more time intervals in any one of sequences 821, 831. In FIGS. 8A and 8B the viewport range of time remains unchanged. However, as discussed above with reference to FIG. 2 a selection operation involving re-sizing a scroll bar can be used to change the viewport range of time.

A particular example of an operation for changing a viewport range of time will now be described with reference to FIGS. 8B and 8C. FIG. 8C is an exemplary display, generally indicated by 803, of a time navigation window being displayed after a user initiated re-sizing of the viewport range of time of FIG. 8B. The display 803 has sequences 823, 833 of time intervals. Particularly, the sequence 823 includes, among other time intervals, time intervals 843, 853 corresponding Quarter 2, 2009, and Quarter 3, 2009, respectively. The display 803 is displayed in response to a user re-sizing of scroll bar 885 in FIG. 8B. The scroll bar 885 is re-sized using thumb position 882 and index position 892 to select a viewport range of time, which includes only Quarter 1, 2009, Quarter 2, 2009, Quarter 3, 2009 and Quarter 4, 2009 as time intervals, which are shown in sequences 823 of FIG. 8C.

Referring back to FIG. 2, each time interval in the sequences 290, 295 is defined by a start time, an end time, and time scale. Example time scales include but are not limited to decade, year, quarter, month, day, hour, minute, and second for example. For example, in some implementations the time interval corresponding to year 2008 in FIG. 2 is defined by a start time 0:00 am, Jan., 1, 2008, an end time of 0:00 am Jan. 1, 2009, and the time scale “year”. In such implementations the end time is exclusive in that time-dependent data associated with the end time of 0:00 am Jan. 1, 2009 to be displayed are not associated with the time interval corresponding to year 2008 but are instead associated with the next time interval corresponding to year 2009, which is defined by a start time 0:00 am, Jan., 1, 2009, an end time of 0:00 am Jan. 1, 2010.

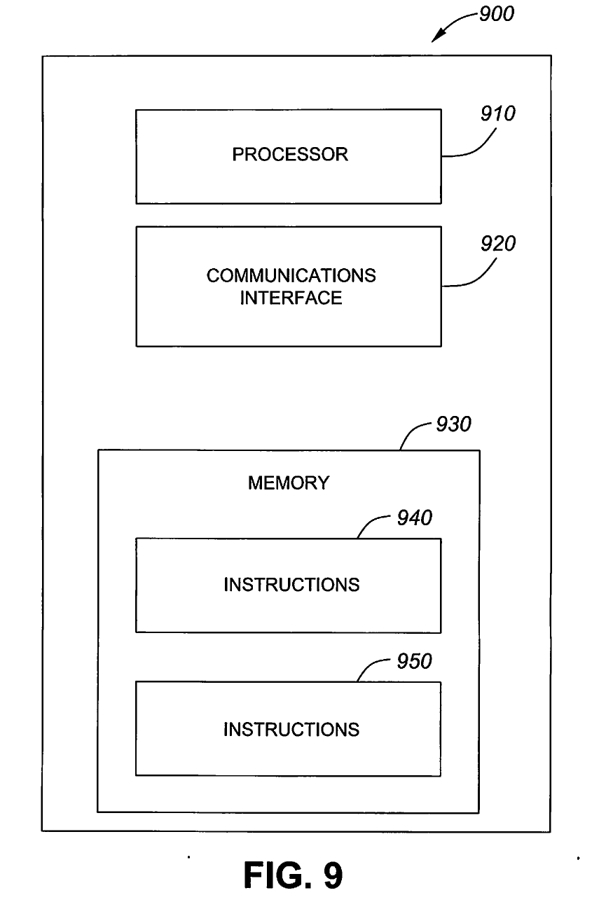

Referring to FIG. 9 shown is a block diagram of a processing device, generally indicated by 900, for providing the display 200 of FIG. 2. The processing device 900 can be any suitable processing device for providing instructions for providing instructions for generating a display such as display 200 of FIG. 2. For example, the processing device 900 may be a PC (Personal Computer) for a user at the PC or a web server for providing web information to multiple users accessing a particular website. The processing device 900 has a processor 910, a communications interface 920, and a memory 930. The memory 930 has instructions 940, 950 stored therein.

The processor 910 processes the instructions 940, 950. With reference to FIG. 2, the instructions 940 form part of a time navigation application and the instructions 950 form part of a dashboard application. The instructions 940 are used for processing instructions received through the communications interface 920 to defining the time navigation window 210, provide instructions for displaying the time navigation window 210, and provide instructions to the dashboard application for displaying data in the charts 220, 230 and the spreadsheet 240 of the dashboard 219. The instructions received through the communications interface 920 include the scrolling, re-sizing, and pre-set state selection operations described above, or any other instruction for defining a time navigation window. The instructions 950 are used for processing instructions for displaying data in the dashboard 219 received from the time navigation application, and providing instructions for displaying a dashboard with data, such has the dashboard 219 of FIG. 2.

In the embodiments of FIG. 9, the time navigation and dashboard applications are described as separate applications. Advantageously, this provides portability of the time navigation application in that in can be in conjunction with other dashboard applications. However, in some embodiments the functionalities of the time navigation and dashboard applications are combined into one application. Furthermore, in FIG. 9 the functionalities of the time navigation and dashboard applications are implemented using instructions 940, 905, the memory 930, and the processor 910. More generally, the functionalities of the time navigation and dashboard applications are implemented using software, hardware, firmware, or any suitable combination thereof.

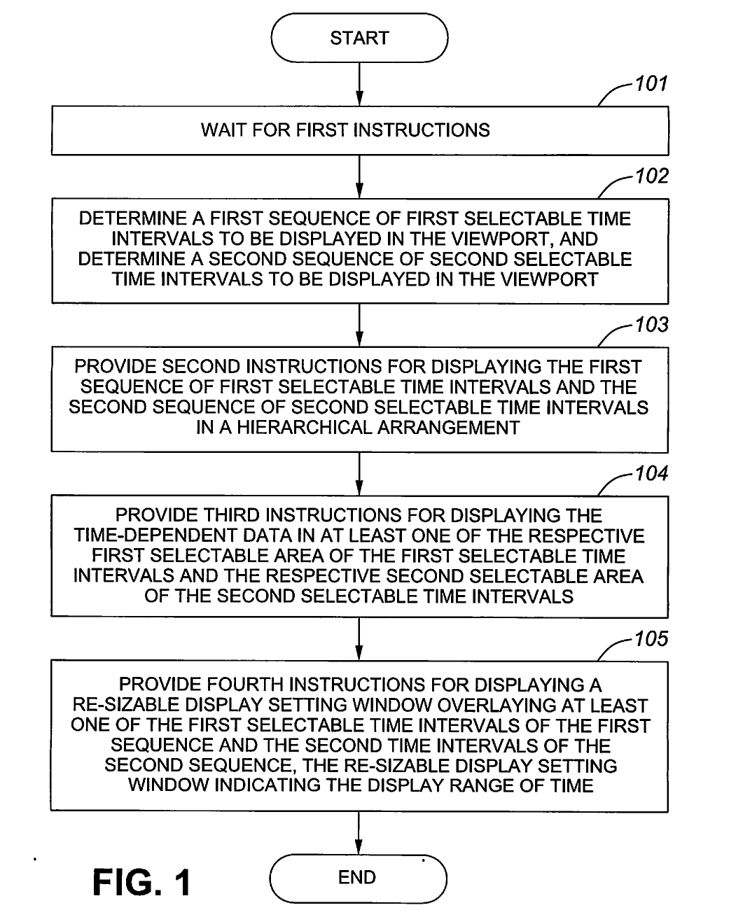

A method of providing instructions for displaying a time navigation window will now be described with reference to FIG. 1. In an exemplary embodiment, the method of FIG. 1 is implemented using the instructions 940 in the processing device 900 of FIG. 9. At step 101, the process waits for first instructions. The first instructions can include instructions defining a range of time for displaying time-dependent data in a viewport and/or instructions defining a display range of time for displaying at least some of the time-dependent data in an area outside the viewport, such as a dashboard for example. When the first instructions are received, at step 102 a first sequence of first selectable time intervals to be displayed in a viewport and a second sequence of second selectable time intervals to be displayed in the viewport are determined. The first selectable time intervals have a first time scale and each have a respective first selectable area for display. The second selectable time intervals have a second time scale different than the first time scale and each have a respective second selectable area for display. At step 103, second instructions for displaying the first sequence of first selectable time intervals and the second sequence of second selectable time intervals in a hierarchical arrangement are provided. At step 104, third instructions for displaying the time-dependent data in at least one of the respective first area of the first selectable time intervals and the respective second area of the second selectable time intervals are provided. At step 105, fourth instructions for displaying a re-sizable selection window overlaying at least one of the first selectable time intervals of the first sequence and the second time intervals of the second sequence are provided. The re-sizable selection window indicates the display range of time. In some implementations, steps 102, 103, 104 are performed only when the first instructions include instructions defining a range of time for displaying time-dependent data in a viewport. Alternatively, in some implementations steps 102, 103, 104 are performed whenever the first instructions require a change in display within the viewport. In addition, in some implementations step 105 is performed only when the first instructions include instructions defining a display range of time for displaying at least some of the time-dependent data in an area outside the viewport. Alternatively, in some implementations step 105 is performed whenever the first instructions require a change in display within the viewport.

In some implementations, additional instructions are provided for displaying selectable and/or manipulatable items. For example, the additional instructions may include instructions for displaying a re-sizable scroll bar for user selection of the range of time for displaying the time-dependent data in the viewport. In some implementations, the additional instructions include instructions for displaying at least one selectable item each defining the range of time for displaying time-dependent data in a viewport. For example, a selectable item may be a selectable button, for selecting a particular year as a viewport range of time.

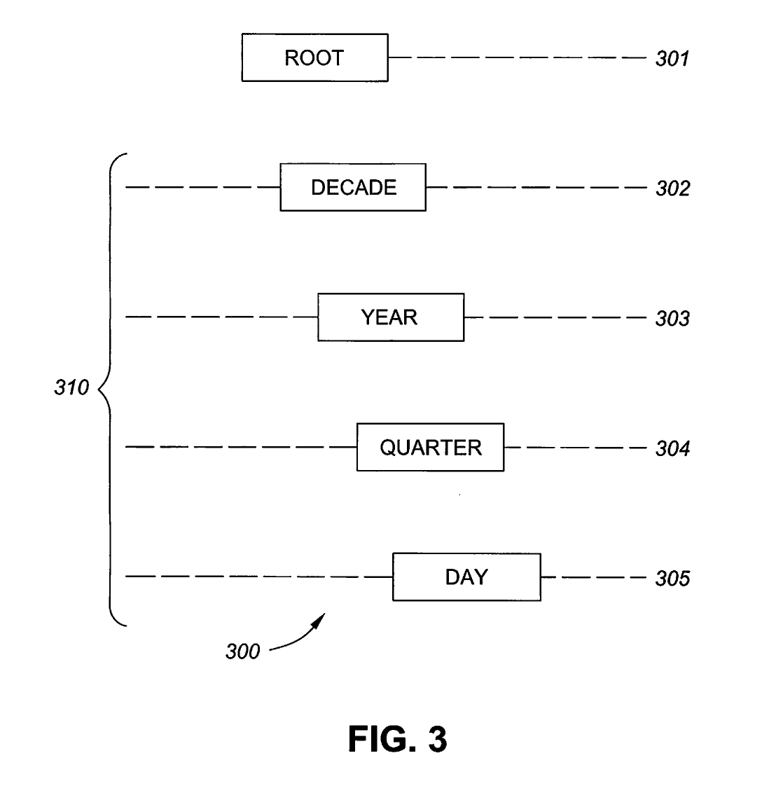

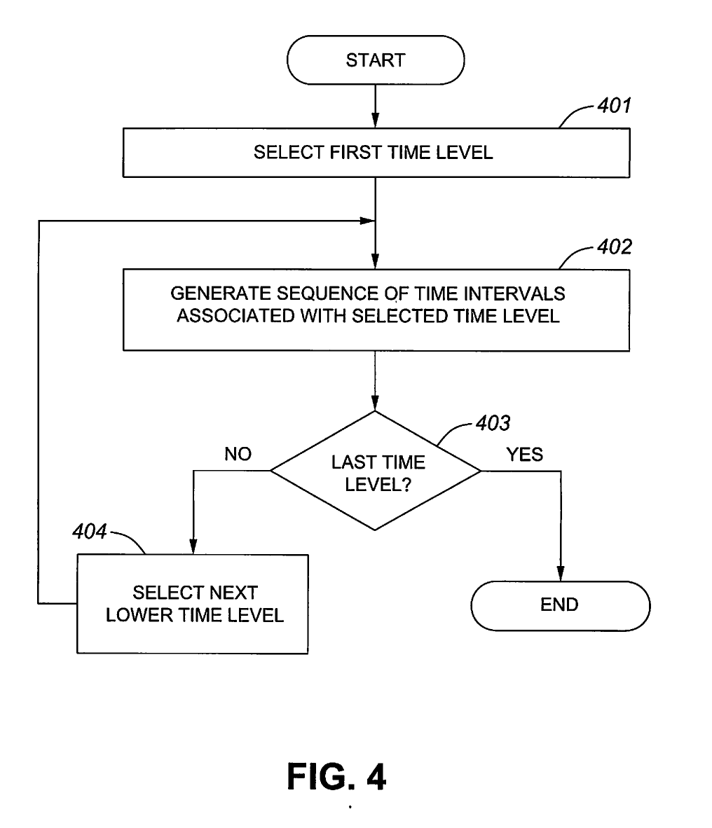

The steps 101 to 105 of FIG. 1 will now be described in more detail with reference to FIGS. 2 to 7. In FIG. 2 while the viewport 215 shows sequences 290, 295 with the time levels or time scales “year” and “quarter”, respectively, other combinations of times levels are possible. For example, other combinations may include “year” and “month” or “month” and “day”, for example. The combination of time levels in sequences 290, 295 are generated based on a specified hierarchical structure. An exemplary hierarchical structure, generally indicated by 300, is shown in FIG. 3. The hierarchical structure 300 has time levels 302, 303, 304, 305 having associated respective time scales. Particularly, time levels 302, 303, 304, 305 have associated with them, decade, year, month, and day, respectively, as time scales. The time scales for each level 302, 303, 304, 305 forms a hierarchical structure 310, which is specified by a program developer. The hierarchical structure 310 is only one of many possible combinations of time scales. Other example combinations include but are not limited to: 1) year, month, day, hour, and 2) quarter, day, hour, seconds. The structure 300 also has a time level 501 identified as “ROOT”. At the ROOT level a time interval is defined by a start time and an end time of the navigation range of time discussed above. A hierarchical structure, such as structure 300, is used to generate sequences of time intervals for display in a viewport. A method of generating sequences of time intervals will now be described with reference to FIG. 4.

In FIG. 4, at step 401 a first time level in a specified hierarchy is selected. For example, with reference to FIG. 3, the first level in the specified hierarchical structure 310 is time level 302. At step 402 a sequence of time intervals associated with the selected time level is generated. At step 403, if the time level is not the last time level in the specified hierarchy then a next time level in the specified hierarchy is selected at step 404 and step 402 is repeated; otherwise, the process ends.

The generation of a sequence of time intervals at step 402 is based on a set of rules that define the attributes of the particular sequence of time intervals being generated. Table I below shows example attributes. However, it is to be understood that these are only exemplary and that other attributes may be used to define the set of rules for generating sequences of time intervals.

TABLE
Listing of attributes of sequences of time intervals being generated, and their
description.

| Attribute(s) | Description |
|---|---|
| Culture | Culture specific settings & language used to output data/time |
| | annotations or labels |
| Calendar | Specifies calendar to use for calculating date/time intervals. |
| | Different calendars define different months, year numerals, etc. |
| | The default may be the Gregorian calendar. |
| Fiscal Offset | The year/month offset from January 1st to denote the beginning |
| | of the Fiscal Year. For example, a (Year, Month) offset of (−3, |
| | 0) is used to specify October 1st as the start of the Fiscal Year. |
| First Day of Week | Specifies the day of week (Sun-Sat) designated as the beginning |
| | of the week. The default may be Sunday. |
| First Day of Week | The day of week (Sun-Sat) used to designate the first week of the |
| of Year | year. The default may be Sunday. |
| First Week of Year | Specifies one of the following: |
| | 1)First Day of Year - the first week of the year begins on the |
| | first day of the year. |
| | 2)First Four Days - If the number of days before the first |
| | occurrence of First Day of Week is greater or equal to 4 days, it |
| | is designated as the first week of the year; otherwise, the first |
| | week of the year begins at the first occurrence of the First Day of |
| | Week. |
| | 3)First Full Week - The first week of the year begins at the first |
| | occurrence of the First Day of Week. |
| | 4)First Day of Week of Year - The first week of the year begins |
| | at the week containing the First Day of Week of Year defined |
| | above. For example, the First Day of Week of Year can be |
| | specified as Thursday and First Day of Week as Sunday. If Jan |
| | 1st is a Wednesday, then Jan 1st-4th is the first week of the year |
| | because it contains Thursday. However, if Jan 1st is a Friday, |
| | the first week of the year would be Jan 3rd-9th. The Default |
| | may be the First Full Week. |
| Week Numbering | Specifies whether weeks are labeled by month or year. Default |
| | is Year. |
| Time Intervals | Specifies the subset of all time intervals that are used to construct |
| | the desired date/time hierarchy. |

The process flow of FIG. 4 allows sequences of time interval to be generated independently of each other. For example, with reference to FIG. 2, the method of FIG. 4 allows the sequences 290, 295 to be generated independently of each other. Furthermore, by generating a set of rules based on attributes, a time interval of a particular time level may be associated with more than one time intervals of a parent (higher) time level. For example, a week interval may span across two distinct month, quarter, or year intervals, for example. The hierarchical arrangements being displayed therefore include a week interval spanning across two distinct month, quarter, or year intervals, for example.

With reference to FIGS. 2 and 3, the sequences 290, 295 correspond to time levels 303, 304 of the structure 310 of FIG. 3 while there are no sequences of time intervals being displayed for time levels 302, 305. It is to be clearly understood that implementations are not limited to displaying only two sequences of times intervals. More generally, one or more sequences of time intervals are displayed. Furthermore the time levels 303, 304 of the structure 310 of FIG. 3, which are associated with the sequences 290, 295 of FIG. 2, are adjacent one another in the hierarchical structure 310. Preferably, sequences of time intervals that are displayed are generated from adjacent time levels in a specified hierarchical structure. However, it is to be understood that in some embodiments sequences of time intervals that are displayed are generated from time levels that are not adjacent one another in the specified hierarchical structure.

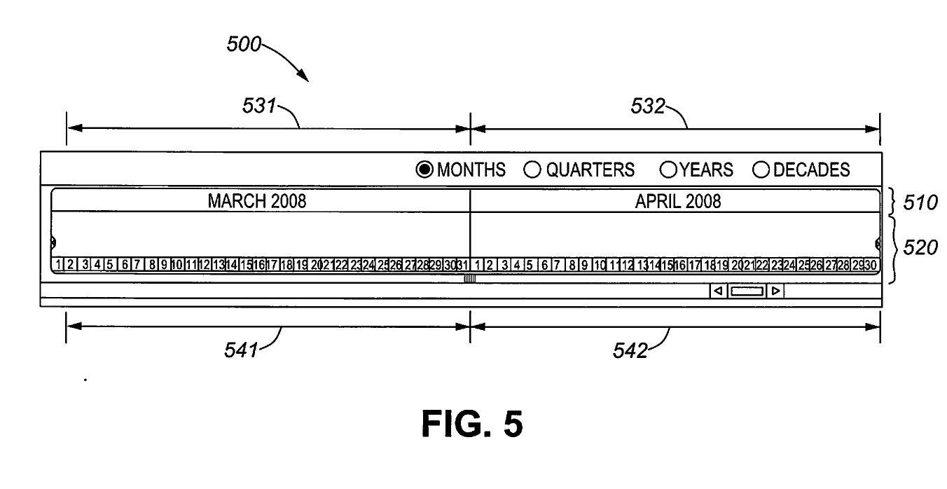

When displaying sequences of time intervals, the time intervals of a particular sequence may vary from one time interval to one another. For example, with reference to FIG. 5 a time navigation window 500 has a first sequence 510 of time intervals corresponding to the months of January and February, and a second sequence 520 of time intervals corresponding to the day of each of the months of March 2008 and April 2008. While the sequence 520 shows 31 time intervals associated with the month of March 2008 there are only 30 time intervals associated with the month of April 2008. As such, the width 531 of the time interval of the sequence 510 corresponding to March 2008 is adjusted to match the width of the time intervals of the sequence 520 corresponding to the 31 days in the month of March 2008. Similarly, the width 532 of the time interval of the sequence 510 corresponding to April 2008 is adjusted to match the width of the time intervals of the sequence 520 corresponding to the 30 days in the month of April 2008. More generally, the width of each interval in a sequence of intervals of a particular time level is adjusted to match the total width of a subset of intervals of another sequence of intervals of a lower time level in a specified hierarchical structure.

With reference back to FIG. 2, as discussed above the scroll bars 275, 280, the thumb positions 271, 281, and the index positions 272, 282 can be used to define the viewport range of time to be displayed as a subset of the navigation range. Since only a subset of time intervals is required to be displayed in order to span the viewport range of time only this subset of time interval needs to be generated and this results in improved performance and efficiency. For example, in FIG. 2 the while the viewport 210 include a viewport range of time between quarter Q2 of 2003 to quarter Q3 of 2010, the navigation range spans over a longer period of time. However, only the time intervals that are required to be generated are the time interval of sequences 290, 295 of the viewport 215.

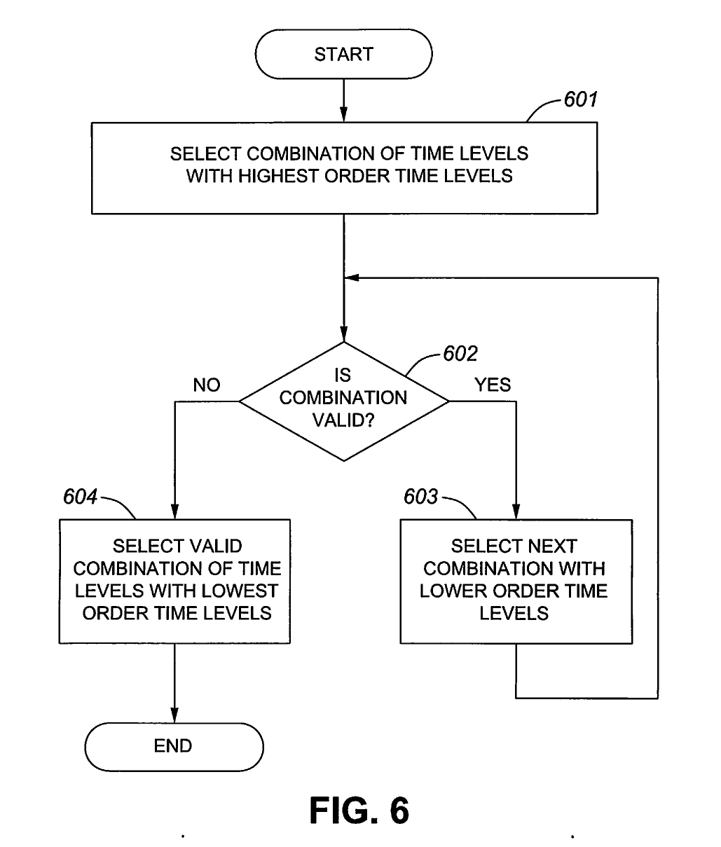

In some embodiments the time intervals for each sequence of time intervals to be displayed in a viewport is determined automatically. More specifically, the time intervals are selected on the basis of the size of the viewport and the range of time of the sequences to be displayed. The selection is made such that the time intervals will occupy an amount of space above a threshold or has a width above a threshold that allows adequate viewing of the intervals and allows annotations or labels within each interval to be legible. An algorithm for determining the time intervals to be displayed will now be described with reference to FIG. 6.

In FIG. 6, at step 601 a combination of time levels with the highest order time level is selected from a hierarchical structure, each level having a respective order. At step 602, if the selected combination of time levels is valid then a next combination of time levels with a lower order is selected and step 602 is repeated for the newly selected combination of time level; otherwise, at step 604 a valid combination of time levels with the lowest order time levels is selected. For example, with reference to FIGS. 3 and 6, at step 601 a combination of time level including time levels 301, 302 is selected at step 601. At step 602, if the selected combination of time levels is valid then a next combination of time levels 302, 303 is selected and step 602 is repeated for the newly selected combination of time levels. Steps 602, 603 are repeated until a non-valid combination is found.

The determination of a whether or not a combination of time levels valid is made on the basis of availability of space for displaying the time interval of a sequence of interval to be displayed in a viewport. More particularly, with reference to FIG. 2, there are 30 time interval in sequence 295 of viewport 215, each having a width 1/30 of the width 211 of viewport 215. For example, an interval 212 of sequences 295 has a width 213 which is 1/30 the width 211 of viewport 215. A user may want to expand the viewport range of time to a point where the width 213 of interval 212 is too small to be displayed and recognizable by the user. Furthermore, the width 213 of interval 212 may be too small to accommodate a label for the interval 213. As such, in some implementations the determination of a whether a particular combination of time levels is valid is based on whether the time interval associated with the time levels has a width that is greater than a predetermined width.

The width 213 of the interval 212 is determined from the width 211 of the viewport 215 and the number of time intervals of the sequence 295 that are to be displayed in the viewport 215. The number of intervals of the sequence 295 that are to be displayed in the viewport 215 depends on the viewport range of time. In some implementations the calculation of the width of a time interval is determined on the basis a sequence of time intervals spanning a range of time greater than the viewport range of time. With reference to FIG. 6, at step 602 the determined width is compared with a predetermined width during the validation process. This results in the selection of a combination of time levels suitable for a range of time larger than the current viewport range of time. As a result a user can scroll through the navigation range to re-define the viewport range without having to re-select a combination of the time levels. Advantageously, this provides improved performance.

With reference to FIG. 2, the time intervals of sequences 290, 295 have labels. For example, the time interval 212 of sequence 295 is labeled with “Q2” and a time interval 214 of sequence 290 is labeled with “2006”. In some embodiments, each time level in a specified hierarchical structure has associated with it two or more label formats each requiring a respective amount of space for display within a time interval and a particular format is selected on the basis of availability of space in the time interval for the label. For example, in some implementations the formats “Quarter X” and “QX”, where X=1, 2, 3, or 4, are associated with the time level of sequence 295 of FIG. 2. However, the size of the interval 212 is too small to accommodate the label “Quarter 4” with format “Quarter X”. On the other hand, the size of the interval 212 is sufficiently large to accommodate the label “Q4”, and this label is selected for labeling time interval 212 of sequence 295. Table II below shows sets of exemplary labels of different formats for each of a number of time scales or levels. It is to be understood that the sets are only exemplary and that other sets or subsets are possible.

TABLE II
Listing of sets of exemplary labels of different formats for each
of a number of time scales or levels.

| Time Scale | Sets of Example Labels for |
|---|---|
| or Level | Different Formats |
| Decade | 2000-2009; 00-09 |
| Year | 2010; ′10 |
| Quarter | Quarter 2; Q2 |
| Month | April, 2009; April; Apr.; A; 4 |
| Day | Friday; Fri.; F |
| Hour | 11:00; 11 |
| Second | 05 seconds; 05 |

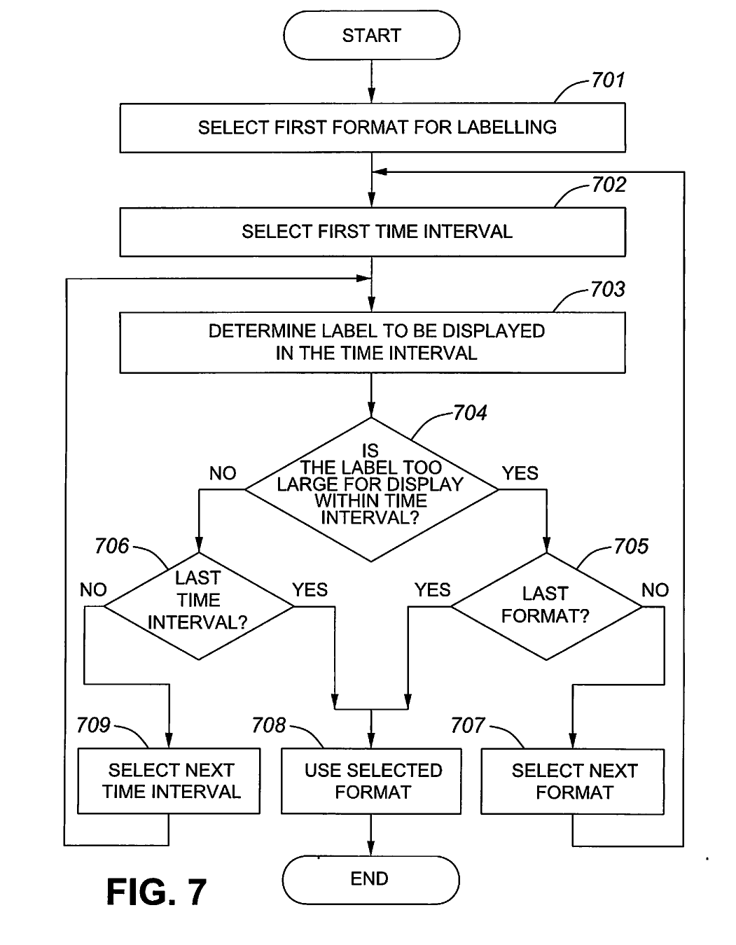

Each format has associated with it a formatting rule defined by a formatting string to which the formatting applies. The formatting rule specifies the formatting string, which is used to select a formatting string. The amount of space required for display is determined from the selected formatting string. The above formatting rule is used to determine which format is best suited for labeling time intervals. With reference to FIG. 7, shown is a method of selecting a format for displaying labels within time interval, in accordance with another embodiment of the invention. The method is applied for each time level to be displayed. As discussed above, for a particular time level there is a plurality of formats available each requiring a respective amount of space for display. At step 701, a first format is selected. The first format being selected corresponds to the format that requires the most amount of space for display among the set of available formats for the particular time level. One or more labels are to be displayed and at step 702 a first time interval is selected. At step 703 a determination of which label is to be placed in the time interval is made. At step 704 if the label is too large for display within the time interval then the process proceed to step 705; otherwise, the process proceeds to step 706. At step 705, if the selected format is not the last available format then at step 707 the next format requiring less space for display is selected and the process returns to step 702; otherwise, at step 708 the selected format is used for labeling the time intervals. At step 706, if the selected time interval is the last time interval to be tested then at step 708 the selected format is used for labeling the time intervals; otherwise, a next time interval requiring labeling is selected at step 709. The process then returns to step 703.

The sizes of the time intervals depend on the number of time intervals to be displayed in the viewport and as discussed above the number of time intervals depends on the viewport range of time. In some implementations, when applying the method of FIG. 7, the size of the time intervals is determined for a range of time that is larger than view port range of time. In such implementations, a user can scroll to re-define a new viewport range of time. However, when scrolling the time span between the start end times of the viewport remains substantially unchanged and there is therefore no need to re-assess whether the selected format is suitable for labeling the time intervals.

Referring back to FIG. 2, the selectable buttons 261, 262, 263, 264 are used to select pre-defined views in the viewport 215. The pre-defined views are defined by start and end times for a new viewport range, from which the time levels and labeling formats can be automatically determined. Alternatively, in other implementations a pre-defined view is defined by the time levels to be displayed. In yet other implementations a pre-defined view is defined by the time levels to be displayed together with a time offset specifying a reference time, such as a start time of the viewport range of time for example.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

I/We claim:

1. A method of providing instructions for displaying time-dependent information and for allowing user selection of time ranges, the method comprising:
responsive to receiving first instructions defining a range of time for displaying time-dependent data in a viewport:
determining a first sequence of first selectable time intervals to be displayed in the viewport, the first selectable time intervals having a first time scale and each having a respective first selectable area for display; and,
determining a second sequence of second selectable time intervals to be displayed in the viewport, the second selectable time intervals having a second time scale different than the first time scale and each having a respective second selectable area for display;
providing second instructions for displaying the first sequence of first selectable time intervals and the second sequence of second selectable time intervals in a hierarchical arrangement; and,
providing third instructions for displaying the time-dependent data in at least one of the respective first selectable area of the first selectable time intervals and the respective second selectable area of the second selectable time intervals.

2. A method according to claim 1 comprising providing fourth instructions for displaying a scroll bar for user selection of the range of time for displaying the time-dependent data in the viewport.

3. A method according to claim 1 comprising providing fourth instructions for displaying a re-sizable scroll bar for user selection of the range of time for displaying the time-dependent data in the viewport.

4. A method according to claim 1 comprising:
selecting at least one of the first selectable time intervals of the first sequence or at least one of the second selectable time intervals of the second sequence; and,
providing the first instructions in response to the selecting at least one of the first selectable time intervals of the first sequence or at least one of the second selectable time intervals of the second sequence.

5. A method according to claim 4 comprising using a mouse wheel for the selecting at least one of the first selectable time intervals of the first sequence or at least one of the second selectable time intervals of the second sequence.

6. A method according to claim 4 comprising using a touch gesture for the selecting at least one of the first selectable time intervals of the first sequence or at least one of the second selectable time intervals of the second sequence.

7. A method according to claim 1 comprising:
responsive to receiving fourth instructions defining a display range of time for displaying at least some of the time-dependent data in an other area outside the viewport, providing fifth instructions for displaying a user re-sizable selection window overlaying at least one of the first selectable time intervals of the first sequence and the second time intervals of the second sequence, the user re-sizable selection window indicating the display range of time.

8. A method according to claim 7 comprising providing sixth instructions for displaying a scroll bar for user selection of the display range of time.

9. A method according to claim 7 comprising providing sixth instructions for displaying a re-sizable scroll bar for user selection of the display range of time.

10. A method according to claim 7 comprising:
re-sizing the user re-sizable selection window; and,
providing the first instructions in response to the re-sizing the re-sizable selection window.

11. A method according to claim 10 comprising using a mouse wheel for the re-sizing the re-sizable selection window.

12. A method according to claim 10 comprising using a touch gesture for the re-sizing the re-sizable selection window.

13. A method according to claim 1 wherein the first time scale has associated with it a plurality of formats for labelling the first selectable time intervals of the first sequence with identifiers of the first selectable time intervals of the first sequence, each format requiring a respective other area for display and the method comprising:
selecting from the plurality of formats a format that has said respective other area suitable for display in the respective first selectable area of the first selectable time intervals of the first sequence; and,
labeling the first selectable time intervals of the first sequence with the identifiers of the first selectable time intervals of the first sequence using the selected format.

14. A method according to claim 13 wherein the second time scale has associated with it a plurality of other formats for labelling the second selectable time intervals of the second sequence with other identifiers of the second selectable time intervals of the second sequence, each other format requiring a respective other area for display and the method comprising:
selecting from the plurality of other formats an other format that has a respective other area suitable for display in the respective second selectable area of the second selectable time intervals of the second sequence; and,
labeling the second selectable time intervals of the second sequence with the other identifiers of the second selectable time intervals of the second sequence using the selected other format.

15. A method according to claim 1 comprising:
providing fourth instructions for displaying at least one selectable item each defining the range of time for displaying time-dependent data in a viewport.

16. A processing device for providing instructions for displaying time-dependent information are for allowing user selection of time ranges, the processing device comprising:
a communications interface;
a processor coupled to the communications interface; and
a memory coupled to the processor comprising first instructions executable by the processor for:
responsive to receiving through the communications interface second instructions defining a range of time for displaying time-dependent data in a viewport:
determining a first sequence of first selectable time intervals to be displayed in the viewport, the first selectable time intervals having a first time scale and each having a respective first selectable area for display; and,
determining a second sequence of second selectable time intervals to be displayed in the viewport, the second selectable time intervals having a second time scale different than the first time scale and each having a respective second selectable area for display;
providing third instructions for displaying the first sequence of first selectable time intervals and the second sequence of second selectable time intervals in a hierarchical arrangement; and,
providing fourth instructions for displaying the time-dependent data in at least one of the respective first selectable area of the first selectable time intervals and the respective second selectable area of the second selectable time intervals.

17. A processing device according to claim 16 wherein the first instructions comprise fifth instructions for:
responsive to receiving sixth instructions defining a display range of time for displaying at least some of the time-dependent data in an other area outside the viewport, providing seventh instructions for displaying a user re-sizable selection window overlaying at least one of the first selectable time intervals of the first sequence and the second time intervals of the second sequence, the user re-sizable selection window indicating the display range of time.

18. An article of manufacture comprising:
a computer usable medium having computer readable program code means embodied therein for providing instructions for displaying time-dependent information and for allowing user selection of time ranges, the computer readable code means in the article of manufacture comprising:
computer readable code means for:
responsive to receiving first instructions defining a range of time for displaying time-dependent data in a viewport:
determining a first sequence of first selectable time intervals to be displayed in the viewport, the first selectable time intervals having a first time scale and each having a respective first selectable area for display; and,
determining a second sequence of second selectable time intervals to be displayed in the viewport, the second selectable time intervals having a second time scale different than the first time scale and each having a respective second selectable area for display;
computer readable code means for providing second instructions for displaying the first sequence of first selectable time intervals and the second sequence of second selectable time intervals in a hierarchical arrangement ; and,
computer readable code means for providing third instructions for displaying the time-dependent data in at least one of the respective first selectable area of the first selectable time intervals and the respective second selectable area of the second selectable time intervals.

19. An article of manufacture according to claim 18 wherein the computer readable code means in the article of manufacture comprises:
computer readable code means for:
responsive to receiving fourth instructions defining a display range of time for displaying at least some of the time-dependent data in an other area outside the viewport, providing fifth instructions for displaying a user re-sizable selection window overlaying at least one of the first selectable time intervals of the first sequence and the second time intervals of the second sequence, the user re-sizable selection window indicating the display range of time.
